(19) United States
(12) Patent Application Publication
(10) Pub. No.: US 2007/0255725 A1
(43) Pub. Date: Nov. 1, 2007

(54) METHOD AND APPARATUS FOR ORGANIZING AND PRESENTING BUILDING SYSTEM INFORMATION

(75) Inventor: Christopher D. McCoach, Englewood, CO (US)

Correspondence Address: SHERIDAN ROSS PC, 1560 BROADWAY, SUITE 1200, DENVER, CO, 80202, US

(73) Assignee: NEW WAKE VENTURE, LLC, Telluride, CO (US)

(21) Appl. No.: 11/734,382

(22) Filed: Apr. 12, 2007

Related U.S. Application Data
(60) Provisional application No. 60/745,702, filed on Apr. 26, 2006.

(51) Int. Cl. G06F 17/30

(52) U.S. Cl. 707/10

(57) ABSTRACT

A method and apparatus for depicting information related to a building or other structure are provided. Information related to aspects of the building is obtained and organized according to the area of the building to which the information pertains. The information may include photographs or video of building systems taken before finishing of the associated area. The information can be accessed by selecting a link to the desired information displayed within the area of interest in a building plan.

### CROSS-REFERENCE TO RELATED APPLICATIONS

This application claims the benefit of U.S. Provisional Application No. 60/745,702, filed Apr. 26, 2006, the entire disclosure of which is hereby incorporated herein by reference.

### FIELD

The present invention is directed to organizing and presenting building system information.

### BACKGROUND

Homes and other buildings increasingly feature complex internal systems and structures. Examples of such internal systems and structures include plumbing, heating, air conditioning and electrical power, alarm system, and communication system wiring. In a finished building, many of these internal systems and structures, hereinafter referred to simply as internal systems, are hidden from view.

After a building is finished, it can be desirable to locate internal systems for modification or repair. In addition, locating internal systems can be important in order to avoid damaging such systems as part of repairs or modifications to other systems or parts of the building. However, because internal systems are often partially or entirely hidden from view, locating them can be difficult.

In order to address the problem of locating internal systems in a finished building, building plans can be consulted. However, the exact location of particular pieces of equipment or interconnections may not follow any predetermined plan that has been prepared. That is, an individual installer may position internal system components where the installer finds it is convenient to do so, rather than according to the plan. Furthermore, internal system components may not be represented in a building plan. Accordingly, formal blueprints or other plan documents are of limited use in locating internal system components.

Another approach to facilitating the location of internal building system components is to take photographs or videos showing the location of such components prior to finishing the building. For example, in a typical home, the plumbing and wiring is in place and visible, prior to the installation of drywall or flooring. Accordingly, photographs or videos taken prior to covering such internal systems with wall or floor material can be taken and later referenced. In order for such photographs or video to be of use after the building is finished, they must include or be associated with reference points, to allow correlation between areas represented by the photographs or video and areas of the finished building. Although photographs or videos can be useful in later locating internal systems, they require careful manual indexing and organization in order to allow relevant portions of the building's internal systems to be easily located after the building is finished.

Following completion of a building, builders will sometimes collect the building plans and/or photographs of the building during construction in a binder that is given to the owner as a reference. However, the creation of such “job folders” is a time consuming burden, and therefore is often not performed by the builder. Moreover, such collections are often disorganized, and it is often difficult to locate or identify information concerning particular systems at particular locations in the finished building.

### SUMMARY

Embodiments of the present invention provide for or assist in the organization and presentation of building system information. In particular, a computer program or system in accordance with embodiments of the present invention provides a tool or construction documenter that can be used to assist a builder or other person in creating a building manual that shows the locations of internal building systems, and in collecting and organizing relevant information. Furthermore, embodiments of the present invention allow building system information to be presented to an end user in an organized and easy to use manner. In accordance with still other embodiments of the present invention, changes made to building systems can be included in building system information by the end user.

The creation of a building manual in accordance with embodiments of the present invention includes taking or obtaining digital pictures of each area of interest within a building. The digital pictures may comprise pictures of some or all of the internal building systems. In particular, pictures of internal building systems that will be partially or entirely hidden from view once the building is finished are taken. The digital pictures are then electronically stored as files in folders organized according to each defined area of the building. For example, each room within a building may comprise an area that is associated with a storage folder or directory.

Another step in the creation of a building manual in accordance with embodiments of the present invention includes taking electronic building plan information and storing that information electronically. For example, computerized automated design (CAD) files comprising the blueprints or plans used in connection with the construction of the building are stored, either in their entirety or in a simplified form for use in connection with the building manual.

In accordance with embodiments of the present inventions, a home page for the building that is the subject of the building manual is also created. The home page comprises a page with a hyperlink to another page or pages that display a portion or all of the building plan. Alternatively, the home page may itself display all or a portion of the building plan. The home page and/or the page presenting the building plan generally includes links to information pertaining to different areas of the building. More particularly, links to information pertaining to different areas of the building may be presented within the corresponding area the building plan. For instance, within the outline of the kitchen on the building plan, a link may be presented to allow information specific to the kitchen area to be accessed. Alternatively or in addition, links to various areas within the building may be presented in the form of a list presented to the user as part of the home page and/or the page presenting the building plan.

Accordingly, by selecting a link visually associated with a particular area of the building, a user can access a page of information pertinent to that area. An example of the type of information that the user can access is digitally stored images. The images can be displayed in their entirety, or in reduced or thumbnail form on the page associated with the selected area, in which case individual images can then be selected for viewing in a larger size (e.g. a larger displayed size and/or a greater resolution image). Alternatively or in addition, the page associated with the selected area can present titles or descriptions that link to files comprising individual images. As used herein, an individual image can comprise an individual photograph, a number of photographs that have been stitched together or otherwise combined, a combination of a photograph and other information added during post-processing of the photograph, a video or other visual information that can be presented to a user.

In accordance with still other embodiments of the present invention, the information that can be accessed by selecting a link corresponding to an area of a building is filtered or determined according to a user-entered selection of a type of information that the user is interested in. For example, from the home page, the user may select a plumbing system link, which causes a page presenting a version or copy of the building plan to be displayed that includes links to pages containing plumbing system information. In particular, the user may select a link within a particular area in order to access information that is particularly directed to the plumbing system within the selected area. As a further example, if the user selects an electrical system link from the home page, a page is opened that presents a version or copy of the building plan from which the user may select a link within a particular area in order to access information that is directed to the electrical system within the selected area.

Other information may also be included. For example, schedules of materials and information regarding the contractors or others that participated in designing, constructing or decorating a particular area of the building may be accessed. As a further example, appliance or component user manuals, links to manufacturer websites and other information can be accessed through the building manual. Furthermore, such other information may be organized according to the defined areas of the building.

### BRIEF DESCRIPTION OF THE DRAWINGS

FIG. 1 is a flow chart depicting aspects of the creation and use of a building manual in accordance with embodiments of the present invention;

FIG. 2 is a block diagram of a system for use in the creation of a building manual in accordance with embodiments of the present invention;

FIG. 3 is a flow chart depicting aspects of the creation of a building manual in accordance with embodiments of the present invention;

FIG. 4 is a flow chart depicting aspects of the creation of a building manual in accordance with other embodiments of the present invention;

FIG. 5 is a flow chart depicting aspects of the use of a building manual in accordance with embodiments of the present invention;

FIG. 6 is a screen shot of an example building manual home page in accordance with embodiments of the present invention;

FIG. 7 is a screen shot of an example page providing access to building electrical information in accordance with embodiments of the present invention;

FIG. 8 is a screen shot of an example page providing access to building plumbing information in accordance with embodiments of the present invention;

FIG. 9 is a screen shot of an example page providing access to building in-floor heat information in accordance with embodiments of the present invention;

FIG. 10 is a screen shot of an example page providing contact information in accordance with embodiments of the present invention;

FIG. 11 is a screen shot of an example page providing access to appliance information in accordance with embodiments of the present invention;

FIG. 12 is a screen shot of an example page providing access to building paint color information in accordance with embodiments of the present invention; and

FIG. 13 is a screen shot of an example page providing instructions for accessing building CAD files in accordance with embodiments of the present invention;

FIG. 14 is a flow chart depicting aspects of the creation and use of a building manual in accordance with other embodiments of the present invention;

FIG. 15 is a screenshot of an example job information page in accordance with embodiments of the present invention;

FIG. 16 is a screenshot of an example blueprint import page in accordance with embodiments of the present invention;

FIG. 17 is a screenshot of an example label your rooms page in accordance with embodiments of the present invention;

FIG. 18 is a screenshot of an example build your library page in accordance with embodiments of the present invention; and

FIG. 19 is a screenshot of building system information being added as content to a library included in a building manual 424 in accordance with embodiments of the present invention.

### DETAILED DESCRIPTION

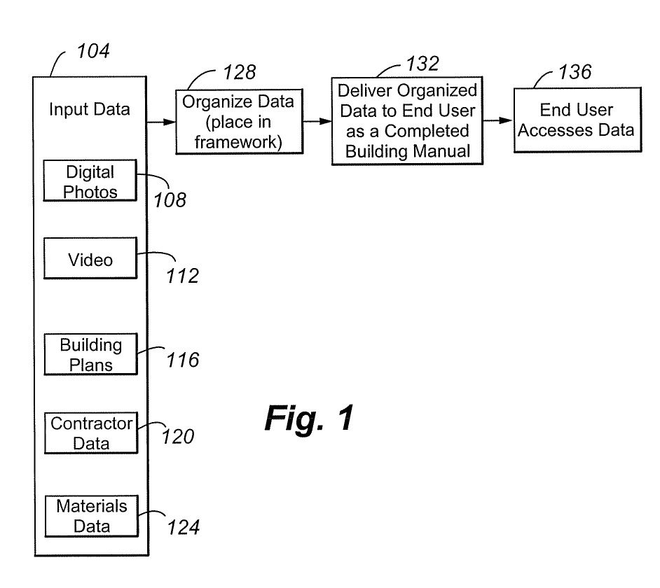

With reference to FIG. 1, a flow chart depicting a process for creating and using a building manual in accordance with embodiments of the present invention is depicted. Initially, at step 104, input data associated with a building is collected. Such input data may include digital photographs 108, video clips 112, building plans 116, contractor data 120 and materials data 124. Furthermore, the digital photographs 108 and/or the video clips 112 typically comprise images of the building's internal systems within the various areas of the building that are taken prior to finishing those areas, so that the location of the internal systems is illustrated. As used herein, an internal system of a building can include any system within the building, and preferably includes systems that are partially or entirely hidden from view after the building is finished. Accordingly, internal building systems can include, without limitation: plumbing; electrical (such as AC power, alarm, network or communication system wiring or components); in-floor heat; heating, ventilation and air-conditioning (HVAC); and built-in vacuum systems.

The input data 104 is then organized at step 128. As will be described in detail herein, organizing data 128 may include storing the various sets of input data 104 in appropriate folders or locations and associating or organizing the stored input data within a framework. In general, the framework assists in the collection and organization of the input data 104. In addition, the framework facilitates access to user selected pieces of information included in the input data 104.

The organized data is then delivered to an end user as a completed building manual (step 132). In accordance with embodiments of the present invention, delivering the organized data may comprise storing (or burning) the organized data to a CD or DVD, or otherwise storing the organized data so that it is available to an end user. In accordance with other embodiments of the present invention, delivering the organized data may also include making the data available to an end user via a network connection.

After delivery of the organized data to the end user, the end user may access that data (step 136). More particularly, the end user may access selected pieces of information included in the input data 104 by accessing selected points or areas within the framework. In accordance with embodiments of the present invention, the end user may access the data via a web browser.

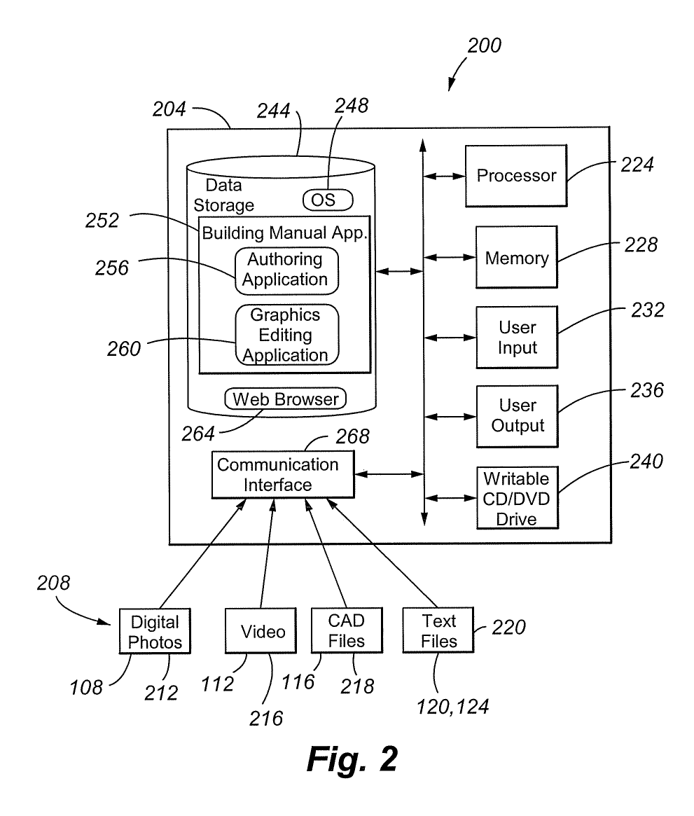

FIG. 2 is a block diagram depicting components that may be included in the system 200 for producing and/or viewing a building manual in accordance with embodiments of the present invention. In general, the system 200 includes a computer 204 that is capable of receiving input data or information 104 from a number of inputs 208. Examples of data inputs 208 that provide data or information 104 include files 212, such as .jpg or .tif files comprising digital photographs or images 108, video 216, such as .mpg files comprising full motion video 112 and building plan 116 files 218, such as .dwg files comprising computerized automated design (CAD) data 116. Other examples of input data or information 104 inputs 208 include text files, such as .doc files comprising contractor 120 and/or materials 124 data, and .pdf files comprising appliance manuals. Accordingly, the inputs 208 may comprise files or data of different types that is obtained from different sources. The data inputs 208 may be provided directly using direct connections to other devices, such as a digital camera or camcorder or to a computer workstation or storage system on which files are stored, or using removable media such as a CD, DVD or floppy disk. The data inputs 208 may also be provided as files transmitted across a network, including the Internet, or as data entered by a user, for example through a user input 232.

The computer 204 may include a processor 224 capable of executing program instructions. Accordingly, the processor 224 may include any general purpose programmable processor or controller for executing application programming. Alternatively, the processor 224 may comprise a specially configured application specific integrated circuit (ASIC). The processor 224 generally functions to run programming code implementing various functions performed by the computer 204. For example, such functions may include processing data received from data inputs 208 or from a user, and producing organized output for access by an end user.

Memory 228 may be provided for use in connection with the execution of application programming by the processor 224, and for the temporary or long term storage of data or program instructions. The memory 228 may comprise solid state memory resident, removable or remote in nature, such as DRAM and SDRAM. Where the processor 224 comprises a controller, the memory 228 may be integral to the processor 224.

In addition, various user input devices 232 and user output devices 236 may be provided. Examples of input devices 232 include a keyboard, numeric keypad, scanner and pointing device combined with a display screen or other position encoder. Examples of output devices 236 include a display screen, printer port, compact flash or other removable memory port. In addition, the computer 204 may include a removable storage device 240, such as a CD or a DVD drive with write capabilities. The computer 204 may additionally include data storage 244 for the storage of application programming and/or data. For example, operating system software 248 may be stored in the data storage 244. Examples of applications that may be stored in the data storage 244 include a building manual application 252 in accordance with embodiments of the present invention. The building manual application 252 may comprise a content authoring application 256 such as a web-authoring (HTML) capability or application. Alternatively or in addition, the building manual application 252 may comprise a content authoring application 256 such as MACROMEDIA FLASH™. In addition, the building manual application 252 may include a graphics editing capability or application 260. A conventional web browser application 264 may also be included. Examples of other functions that may be provided by the building manual application, either as integrated functions or by separate applications used together to comprise a building manual application 252, include word processing and spreadsheet programs. Data stored in the data storage may include input data 104. Also, a set of data and/or functions comprising the content of a framework for a building manual in accordance with embodiments of the present invention may be stored in the data storage 244. Alternatively or in addition, data and/or functions comprising a building manual application can be stored in removable media accessed by a suitable device (e.g., a CD-ROM drive) or stored on a remote computer or storage device.

In accordance with embodiments of the present invention, the building manual application 252 may further comprise an executable application that can be run by an end user in association with a computer 204. Accordingly, the building manual application 252 may include instructions, the execution of which result in the display of various pages of the building manual or construction documenter. Moreover, the building manual application 252 may allow the user to access the data associated with the stored building systems information included as input data 104 associated with the system 200. The building manual application 252 can include programming code to enable an end user to modify information included as part of the building manual, or to add new information to the building manual, for example as modifications are made to the building systems over time. Accordingly, embodiments of the present invention provide a tool that can be used to adapt a building manual to changes in depicted building systems or to enhance information already included in a building manual.

A communication interface 268 may be provided to interconnect the computer 204 to input devices 208. Accordingly, a communication interface 268 may comprise a universal serial bus (USB), IEEE 1394, RS-232 or other communication port. Alternatively or in addition, a communication interface may comprise a wireless communication port, such as an IrDA port. Furthermore, a communication interface 268 may comprise a wire line or wireless network interface, such as a network interface card (NIC), Bluetooth, WiFi, or other network interface to place the computer 204 in communication with other computers or devices. Moreover, a number of different communication interfaces 268 may be provided as part of a single computer 204.

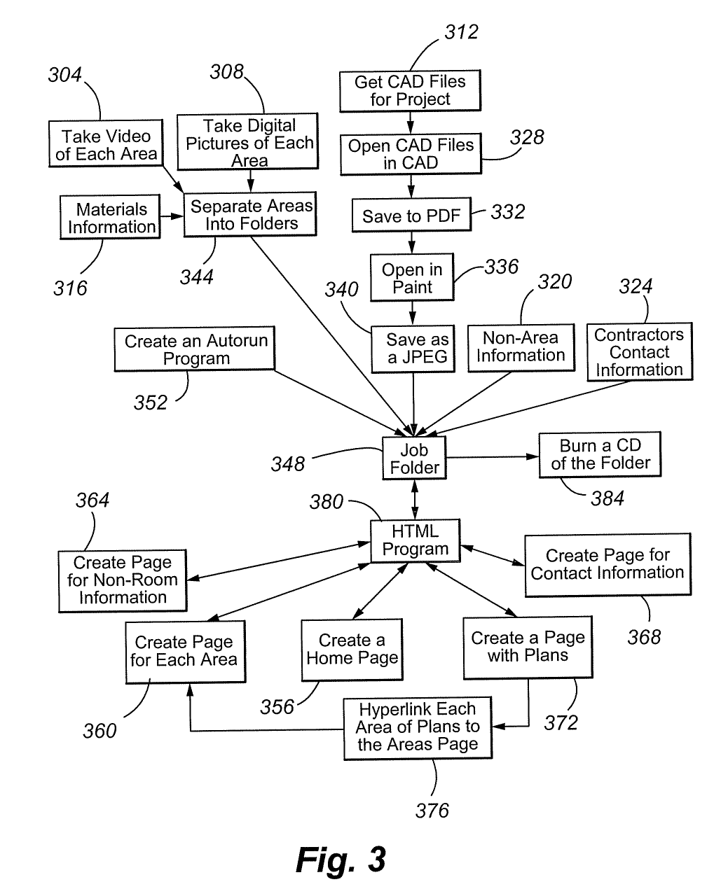

In FIG. 3, aspects of the creation of a building manual in accordance with embodiments of the present invention are illustrated. As shown in FIG. 3, a number of different paths comprise steps of inputting or importing data 104. For example, video may be taken of each area or room within the building for which the building manual is being prepared to obtain video files 216 (step 304). In addition, digital pictures may be taken of each area within the building to obtain digital photographs 212 (step 308). In general, video clips and photographs will include images taken prior to finishing of the building, so that internal building systems are in view. As still another form of data input, CAD files 218 comprising or associated with the building plan may be obtained from an architect's or builder's workstation or other computer (step 312). Other sources of input data include text files 220 comprising materials information (step 316) and non-area related information (step 320). In addition, contractor contact information and other contractor data 324 can be obtained.

Inputting data 104 may include editing data. For example, in connection with CAD files 218 comprising a plan of the building, editing may be performed to remove unnecessary information and/or reduce the size of the associated file. Accordingly, obtaining CAD information may include opening the CAD files 218 in a CAD program (step 328) and editing the files to remove (or add) information as desired. For example, a complete set of building blueprints can be reduced to a floor plan for each floor of the building. The CAD files 218 may then be saved in a common file format, such as in the portable document format (.pdf) (step 332). The files may then be opened in a graphics editing program, such as Microsoft Paint® and further editing may be performed, if desired (step 336). The edited file may then be saved as an image, for example as a JPEG (.jpg) file (step 340). Similarly, other input data 104, such as digital photographs 212 or video 216 can be edited in suitable graphics or video editing programs, while other information, such as materials information, non-area information and contractor contact information can be edited by using a word processing program. Still other building system information, such as appliance manuals, may be imported and stored as JPEG files.

In connection with data that is specific to a particular room or area of the building, such as video 304 or pictures 308 of the different areas, and materials information 316 related to particular areas, such data may be sorted by area. In particular, input data associated with different areas may be saved into different folders (step 344). For example, in connection with a building manual for a residence, different folders may be established for storing data relating to the different areas comprising kitchen, dinning room, living room, bedrooms, bathrooms, family room and halls. Moreover, different types of information pertaining to a particular area may be saved in different folders. For example, for an area comprising a kitchen, a separate folder may be created for storing each of plumbing system, electrical system and in-floor heat system information. As can be appreciated by one of the skill in the art, the different folders may comprise different directories or sub-directories within a data storage apparatus. The folders created for different areas of the building and the included data may be saved to (or established under) a parent or job folder or directory (step 348). In addition, the building plans 312, non-area related information 320 and contractor contact information 324 may be saved to the job folder 348. In addition, an autorun program created for the building manual at step 352 may be saved to the job folder 348. As can be appreciated by one of still in the art after consideration of the present disclosure, other hierarchies or arrangements of information in folders or directories are also possible.

The various data and programming maintained in connection with the job folder 348 may be used in association with or to provide content for pages of Flash, HTML, or other code. Accordingly, the creation of a building manual in accordance with embodiments of the present invention may include creating a home page (step 356). The home page may include information identifying the building that is the subject of the building manual, and provide links to information related to various areas and/or types of information about the building. Accordingly, the home page may comprise the introductory screen displayed to a user upon running or accessing a building manual in accordance with embodiments of the present invention. In addition, one or more pages for each of the different areas defined in connection with the building may be created (step 360). Furthermore, a building manual may provide different types of information for one or more areas of the building, in which case a single area may have a page for each different type of information associated with that area. Typically, but not necessarily, the number of pages for area related information corresponds to the number of folders for area-related information created in step 344. A page for non-room related information (step 364) and contact information (step 368) may also be created. Moreover, a page for each different type of non-room related information and/or contact information may be created. In addition, a page with the building plans is created (step 372). The page containing the building plans includes hyperlinks to each page related to an area of the building (step 376). Where different types or categories of area related information are included in the building manual, a different page of building plans with links to a particular set of area pages may be provided for each type of area related information. The various pages may be accessed through, created, and/or formatted using a Flash, HTML or other program (step 380) and stored in the job folder 348. In general, information comprising at least a portion of content of the various pages is the information stored in the job folder 348 as part of the input steps described previously. The completed job folder 348 comprising the program 380, which includes the input information 104 referenced by or included in the various pages is then written to a CD or otherwise stored for later access or use by an end user (step 384).

In general, the process described in connection with FIG. 3 can be performed by using a number of different application programs that are commonly available in concert. For instance, CAD files comprising a building plan can be accessed by using AutoCAD®, available from Autodesk®. The CAD files can be converted to jpeg files using Microsoft Paint®, after converting the CAD files to a pdf format using AutoCAD®. The editing of digital pictures may be performed using Adobe Photoshop®, and the editing of video can be performed by using Adobe Premier®. The editing of textual information may be performed by using Microsoft Word®. Adobe Acrobat® may be used to create and edit .pdf files. The creation of web pages and content may be performed by using Macromedia Dreamwaver® and/or Macromedia Flash Professional®. Accordingly, a building manual process application 252 in accordance with embodiments of the present invention may comprise a plurality of discrete application programs.

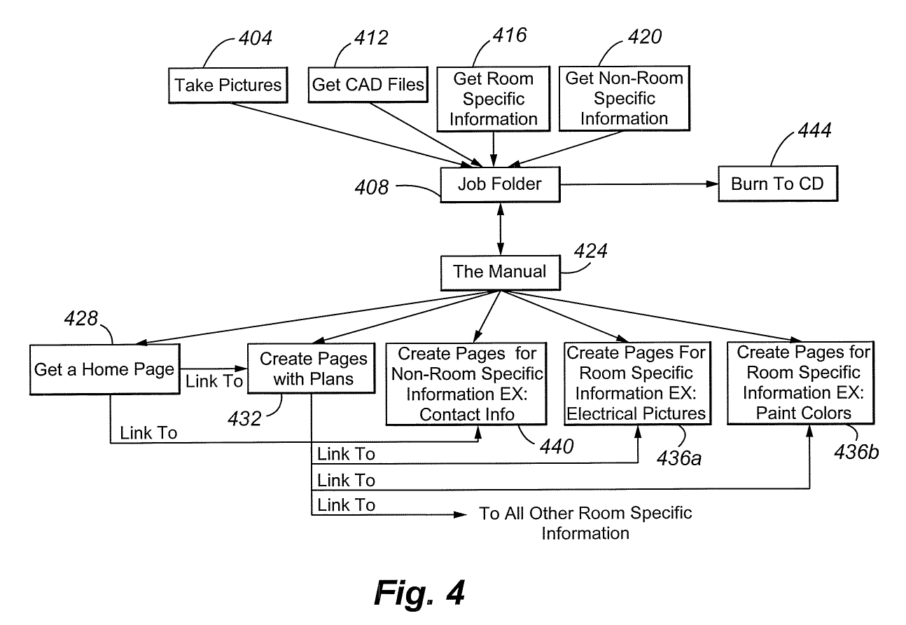

The process for creating a building manual in accordance with other embodiments of the present invention, illustrated in connection with FIG. 4 uses an integrated building manual application 252. Accordingly, rather than needing to access different programs, the user may instead use just the building manual application 252 (or the building manual application 252 and a lesser number of other applications). With reference to FIG. 4, at step 404 pictures 108, 212 and/or video 112, 216 of the different areas within the building are taken and saved or imported to a job folder 408. At step 412, CAD files or other building plans 116, 218 are saved or imported to the job folder (step 408). Room specific information (step 416) and non-room specific information (step 420) is also saved or imported to the job folder. The job folder may comprise sub-folders containing information related to specific areas of the building. The job folder may additionally or alternatively comprise a folder for each different type of internal system included in or represented by the input data for some or all of the areas of the building, and the folders for the different internal building systems can include sub-folders for different rooms or areas of the building. The data and information input to the job folder is made available to or integrated with the building manual 424. In general, the building manual 424 comprises a framework for the organized storage and presentation of the building information and data. The creation of the complete building manual 424 may comprise the creation of a home page 428 that provides links to a number of other pages (step 428). Creating a building manual 424 also includes creating one or more pages of building plans with links to room specific information (step 432). The specific room related information may be stored in separate pages (step 436). For example, different pages 436a may be created for presenting information for each of the different rooms or areas in the building related to the electrical system within each area. As a further example, different pages may also be created for the different rooms for providing information related to paint colors 436b. Accordingly, the different area specific pages for different types of building system information present the input data 104 (e.g. digital photographs) associated with a particular area and type of information to the end user. Pages for non-room specific information may also be created (step 440). The various pages, and the associated data are saved within the job folder 408, which then can be written to a CD or otherwise saved as a completed building manual 424 for later access by a user (step 444). In accordance with embodiments of the present invention, the building manual 424 may comprise a program that can be used by the end user to add additional or revised content as additions or changes are made to building systems and/or the associated building.

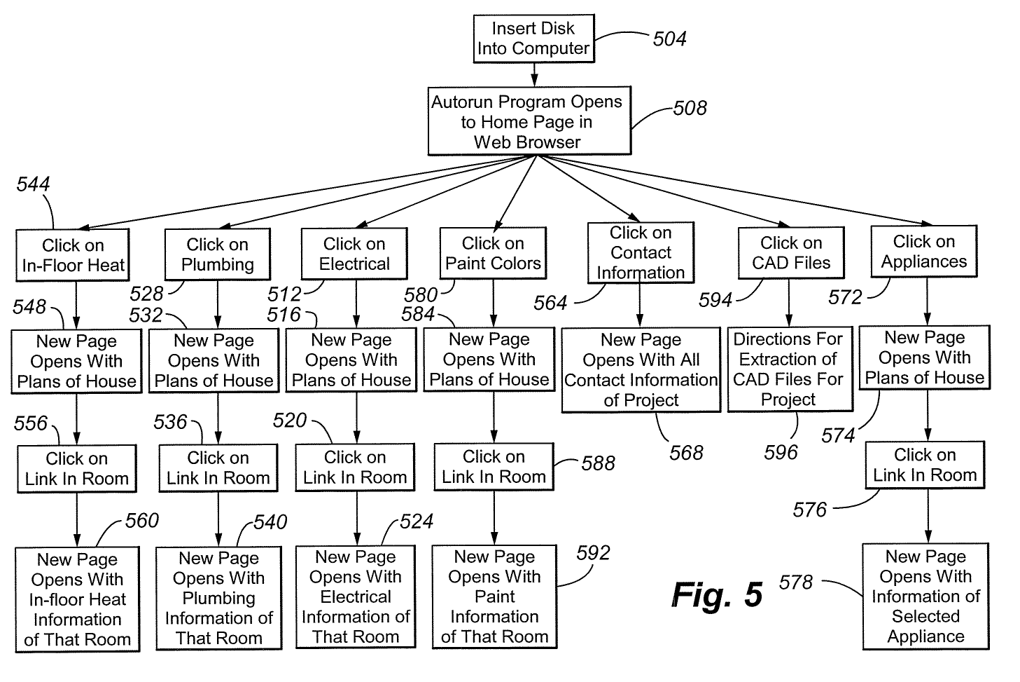

FIG. 5 is a flow chart depicting aspects of the use of a building manual in accordance with embodiments of the present invention. More particularly, the use of a building manual that has been stored on a piece of removable storage media, such as an optical disk (e.g., a CD) is illustrated. Initially, at step 504, the disk containing the building manual is inserted into an appropriate drive of a computer 204. The computer 204 used to access the building manual does not have to include a building manual application 252. Instead, all that is required is an application capable of accessing the content of the disk containing the building manual. For example, in accordance with embodiments of the present invention, a web browser 264 may be used to access the content of the disk. The building manual disk may include an autorun program that opens the manual home page in the web browser 264 after the disk containing the building manual has been inserted into the computer.

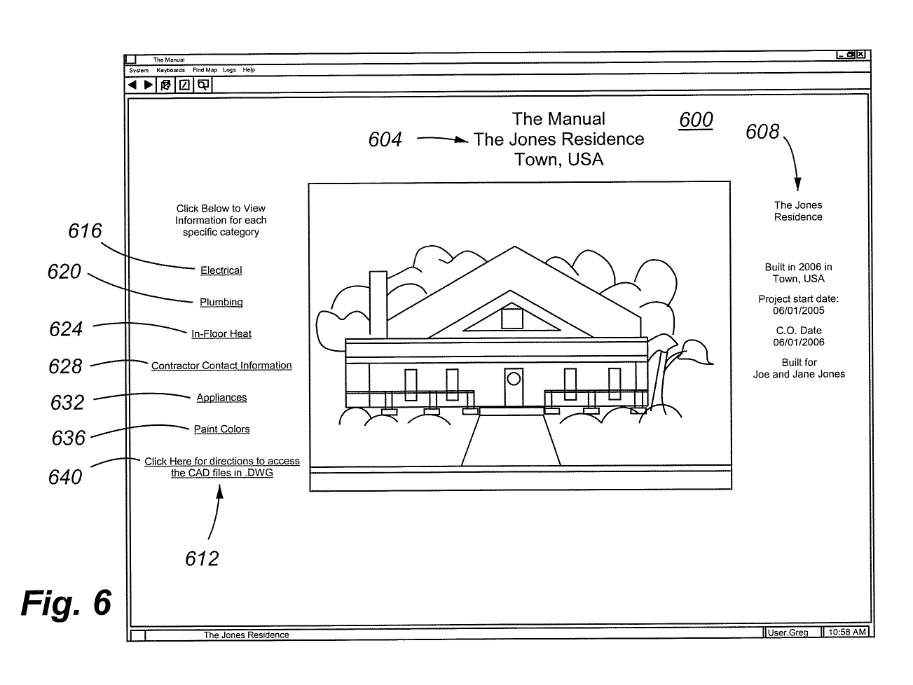

An example building manual home page 600 is illustrated in FIG. 6. As shown in FIG. 6, the building manual home page 600 may include an identification of the building that is the subject of the building manual is directed to (604). Additional identifying information 608 may also be presented by the home page 600. The home page generally presents a number of links 612. By selectively accessing the provided links 612, for example by manipulating a pointer using a user input 232 comprising a pointing device such as a mouse and a user output 236 comprising a monitor or visual display, an end user may select one of the links 612.

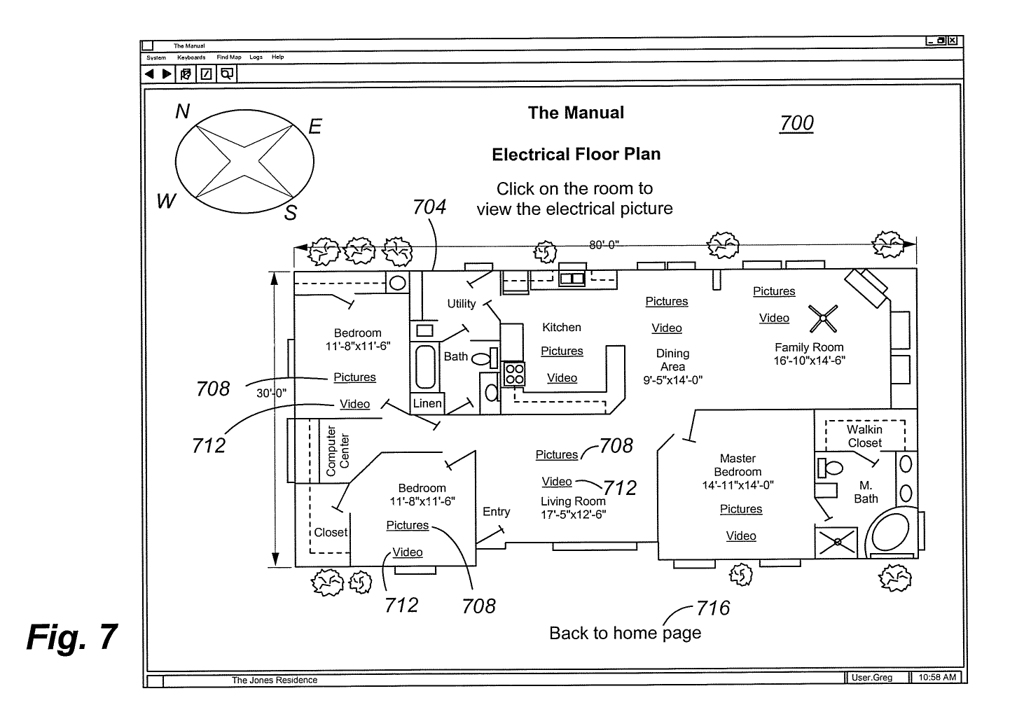

With reference to both FIGS. 5 and 6 if the user selects the “electrical” link 616 by clicking on that link (step 512) a new page opens displaying plans of the building that is the subject of the building manual (step 516). An example of electrical information page 700 that is opened in response to clicking on the electrical link 616 is illustrated in FIG. 7. As shown in FIG. 7, the electrical information page 700 comprises a floor plan showing the various areas or rooms of the building in the form of the building plan 704. The building plan 704 that has been displayed may be simplified, for example by removing details of the building's construction or layout and notations, such as construction details and dimensions, that are deemed unnecessary. Within the areas of the building represented by the plan, links may be provided to access detailed electrical information related to that area of the building. For example, links to pictures 708 and/or links to video 712 may be provided. Accordingly, an end user may select one of the displayed links 708, 712 (step 520) to access digital photographs 108 and/or video 112 related to the area with which the selected link is associated. For example, if the end user selects the link to pictures 708 associated with the area labeled “living room” within the building plan 700, a new page is opened (step 524) that displays or provides access to one or more digital photographs of the electrical system or systems within the living room of the building. Typically, the photographs 108 comprise photographs of the electrical system within the associated area prior to finishing of that area, so that those electrical systems are entirely, or at least more fully, in view. In the case of links to digital photographs 708, clicking on the link may display one or more digital photographs associated with the area in their entirety, or thumbnails that allow access to a more detailed image by making a further selection of one of the thumbnails. Similarly, in the case of links 712 to video information, selecting the links 712 may cause a page that displays thumbnails comprising a frame of the video that can be selected by the user for viewing. By selecting a thumbnail, a media player may be launched to play the associated video file. Alternatively, selecting a video link 712 may cause a media player to be launched and to play a single or integrated video file of the electrical system for the area. The electrical information 700 may additionally include a link 716 for returning to the home page 600.

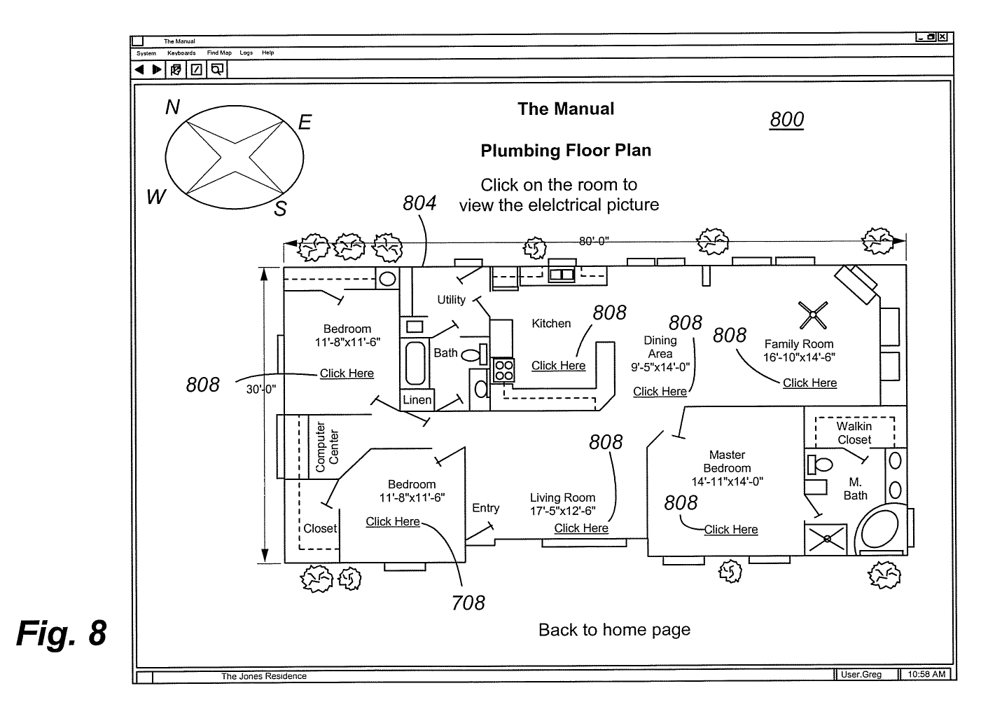

With reference to FIG. 8, an example of a page 800 that may be displayed to an end user in response to selection by the end user of a plumbing link 620 (steps 528 and 532) displayed by the home page is illustrated. In general, it can be seen that the plumbing page 800 includes a depiction of the building plan 804 that is similar or identical to the building plan 704 displayed by the electrical page 700. For example, embodiments of the present invention may use a depiction of the building plan that is common to each page containing links to information that is specific or directed to particular areas of the building. Within the areas of the building, links 808 are provided to access detailed information regarding the associated area. In particular, the links 808 included in the areas of the building plan 804 illustrated on page 800 allow an end user to access digital photographs 108 of the building plumbing systems prior to finishing of the building. In particular, by clicking on a link 808 for the area of interest (step 536), another page is opened (step 540) that allows digital photographs of the plumbing system within that area to be viewed. Alternatively or in addition, accessing the links 808 may provide access to video files 112 related to the area with which the selected link 808 is associated.

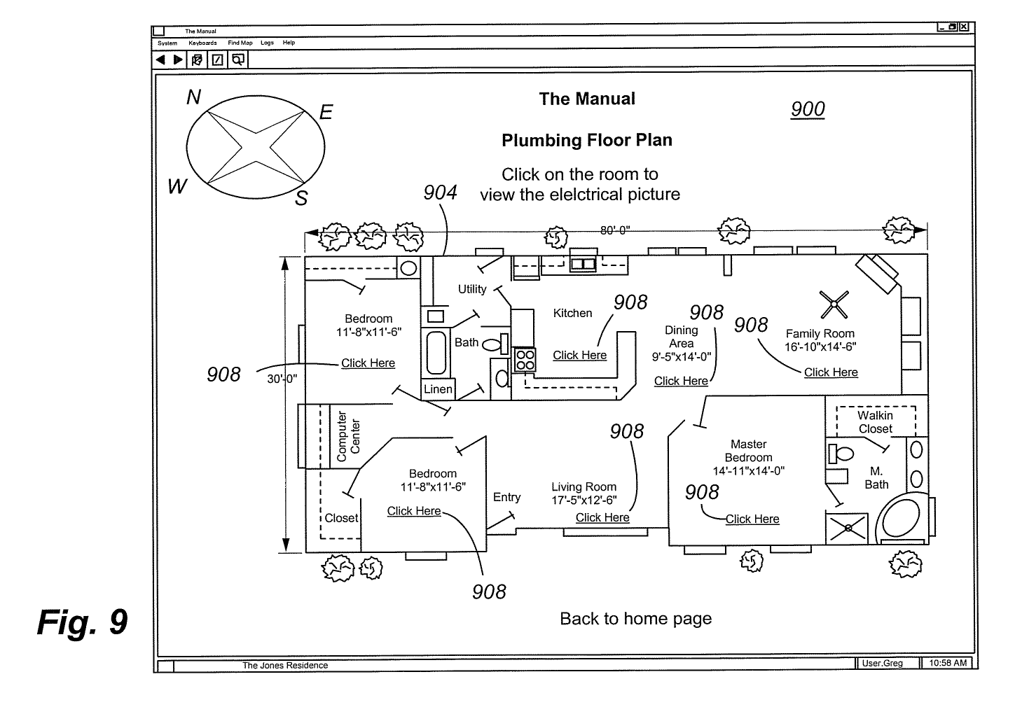

With reference to FIG. 9, an example of a page 900 that may be displayed in response to the selection of an in-floor heat link 624 (step 544) on the home page 600 is illustrated. In particular, the in-floor heat page 900 displays a building plan (step 548) that is similar or identical to the building plan 704, 708 displayed by other pages. In addition, the page 900 includes links 908 that can be selected in order to access digital photographs of the in-floor heat systems included in the different areas of the building prior to finishing. In particular, by clicking on a link 908 for the area of interest (step 556), another page is opened (step 560) that allows digital photographs of the in-floor heat system within that area to be viewed. Alternatively or in addition, selecting one of the links 908 may provide access to video files 112 of the associated area.

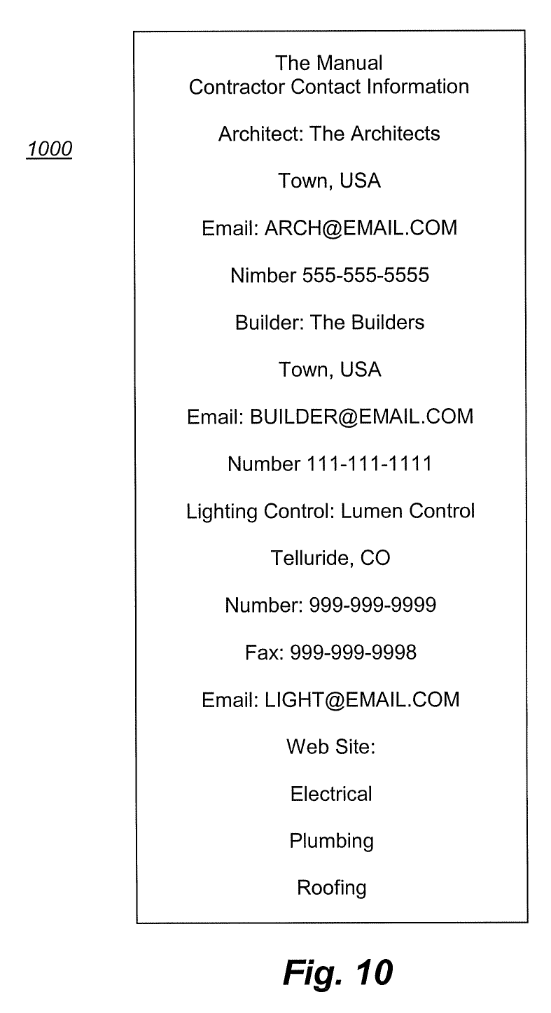

An end user may also access additional information from the home page 600. For example, by selecting the contractor contact information link 628 (step 564), a new page 1000 (see FIG. 10) is opened that displays contact information for different parties involved in the building project (step 568). For example, contact information for the architect, builder or other contractors or parties may be displayed.

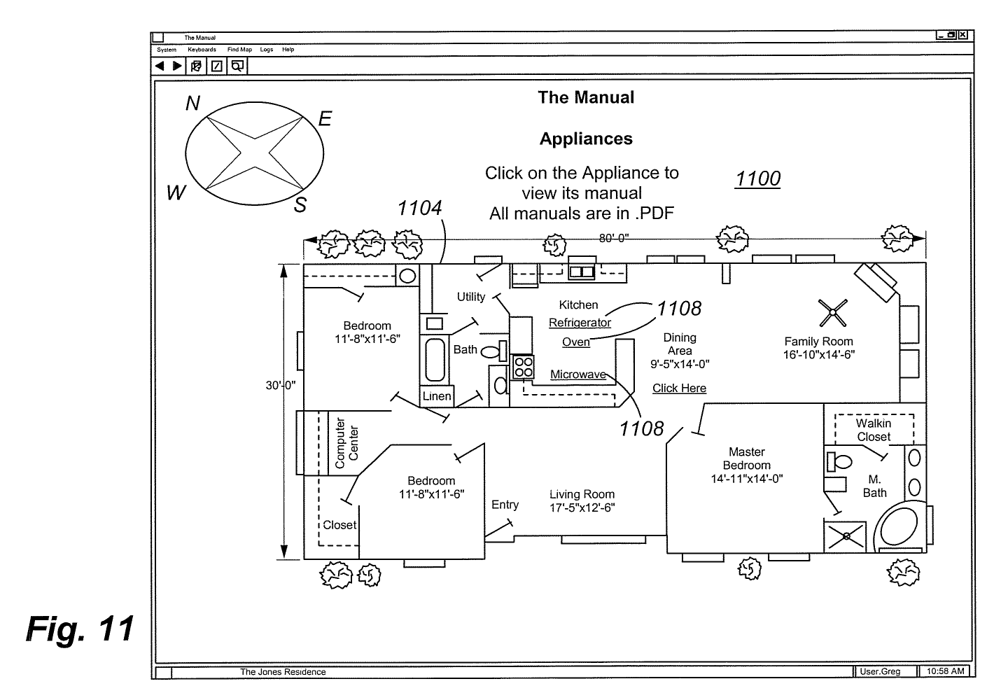

As a further example, by selecting the appliances link 632 (step 572) the user may cause a new page 1100 (see FIG. 11) to be opened related to installed appliances (step 574). The appliances page 1100 may include a depiction of the building plan 1104 that is similar or identical to the building plan 604, 704, 804, 904 used in other pages. The appliances page 1100 may include links 1108 that allow the user to access appliance manuals or other information related to a selected appliance or appliances. In particular, by clicking on a link 1108 for the appliance of interest (step 576), a new page is opened displaying information related to the selected appliance (step 578). Moreover, the links 1108 for each appliance for which information is provided, may be displayed in association with the area of the building in which the appliance is located. Therefore, it can be appreciated that area related information can include information other than pictures of building systems.

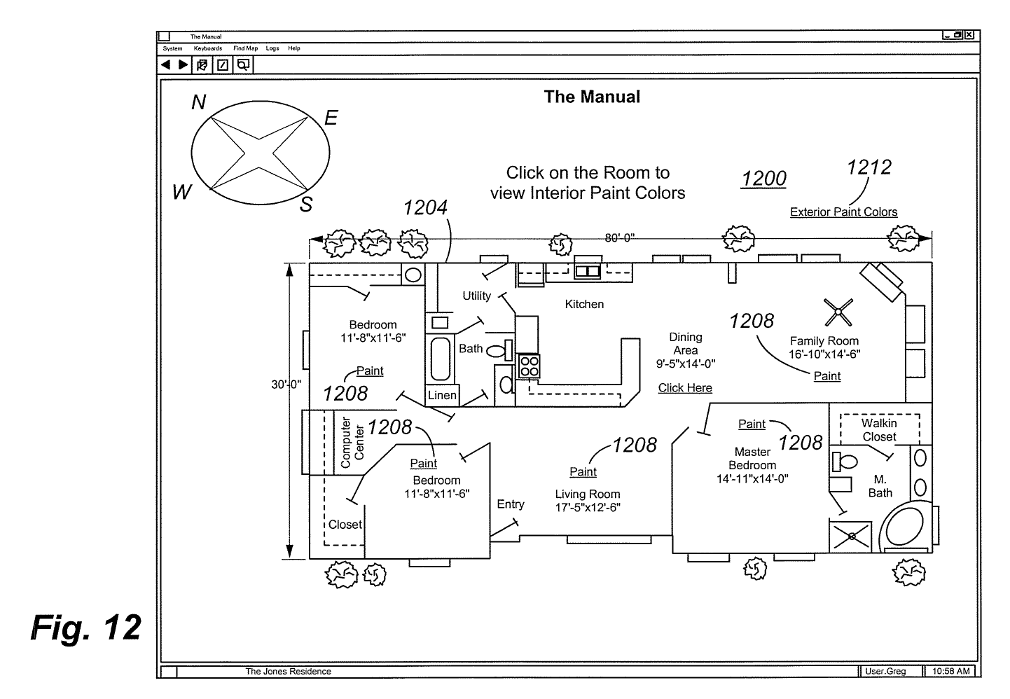

The selection of a paint colors link 636 (step 580) causes a new page 1200 (see FIG. 12) to be opened. The paint color page 1200 includes a depiction of the building plan 1204 that is similar or identical to the building plans 704, 804, 904, 1104 used by other pages in the manual (step 584). Links 1208 may be provided within the areas of the building to allow access to lists of paint colors used in the associated area. In addition, one or more links 1212 to exterior paint color information may be provided. Therefore, it can be appreciated that “areas” of a building can include areas external to the building.

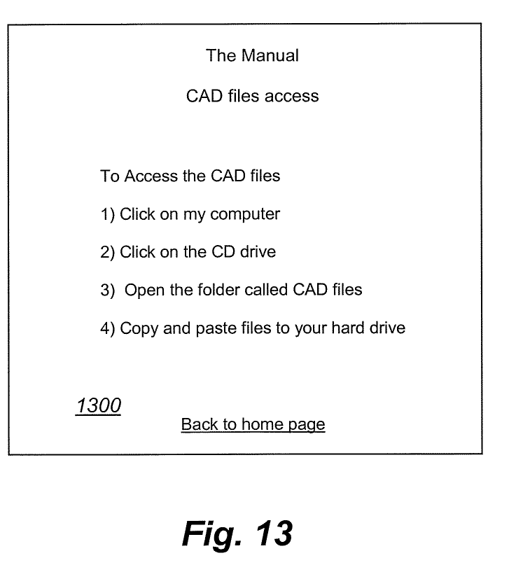

A user may access the building plans by selecting a link 640 on the home page 600 (step 594). Clicking on the link may result in the display of a page 1300 (see FIG. 13) that includes directions for extracting CAD files for the project (step 596).

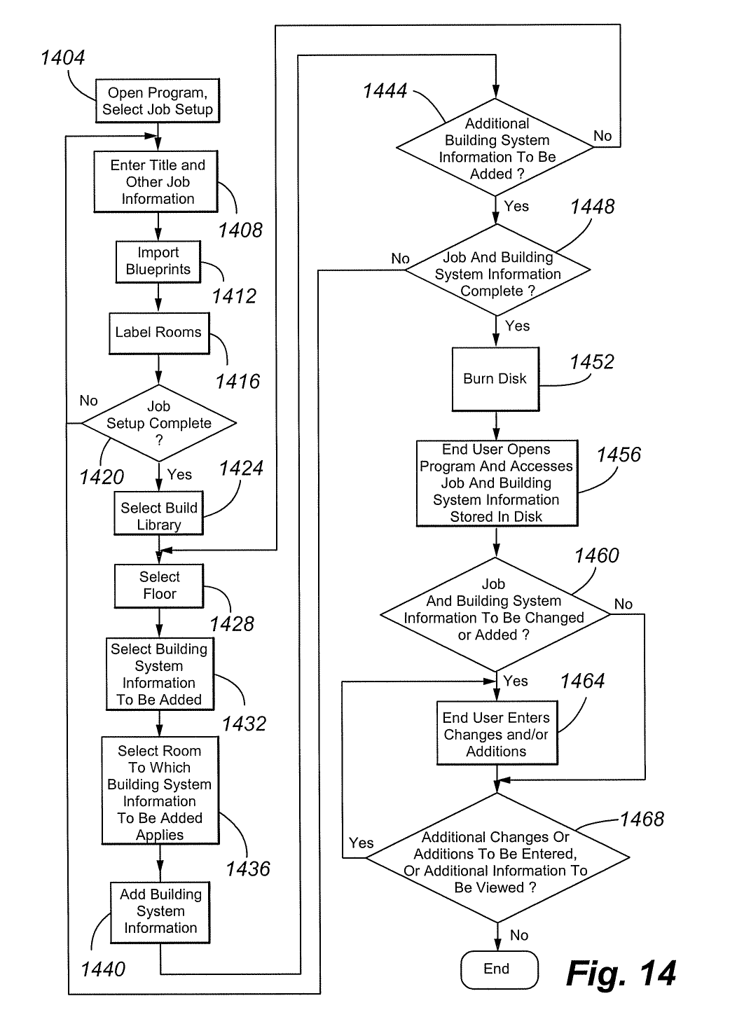

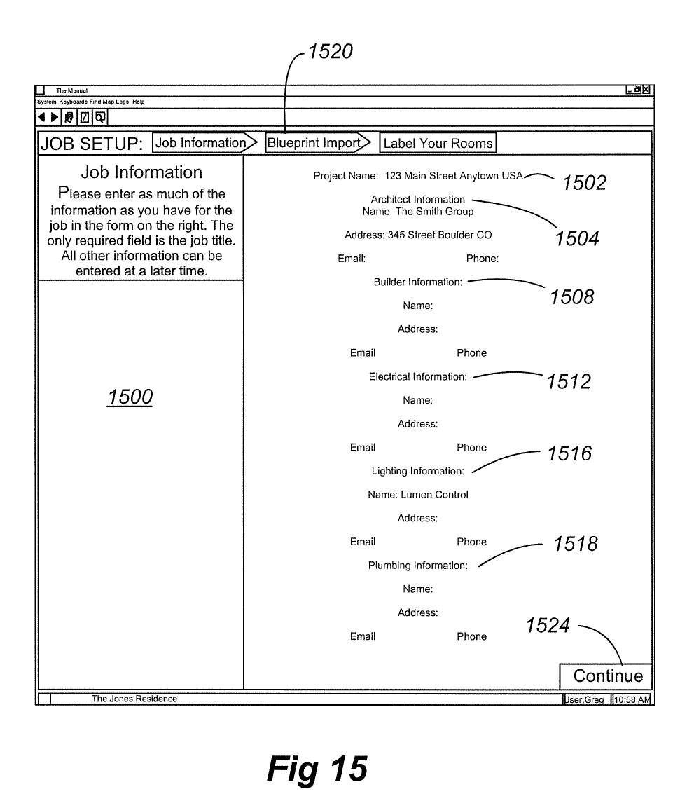

FIG. 14 is a flow chart depicting aspects of the creation and use of a building manual in accordance with further embodiments of the present invention. Initially, at step 1404, building manual application or program 252 is opened, and the user can make a selection to either begin a new project or to modify an existing project. These selections may be made, for example, by selecting labeled buttons presented as part of the user interface. In the present example, the user will select the new project or job setup button. In response, the user is presented with ajob information page having fields for the entry of information related to the project or building associated with the building manual 424 being created. An example job information page 1500 is illustrated in FIG. 15. On that example page 1500, a field for the project name 1502 is included, and allows the building manual 424 being created to be identified. The illustrated groups of information include architect information 1504, builder information 1508, electrical information 1512, lighting control information 1516 and plumbing information 1518. Name, address, email, phone or other fields may be included within each group 1504-1518.

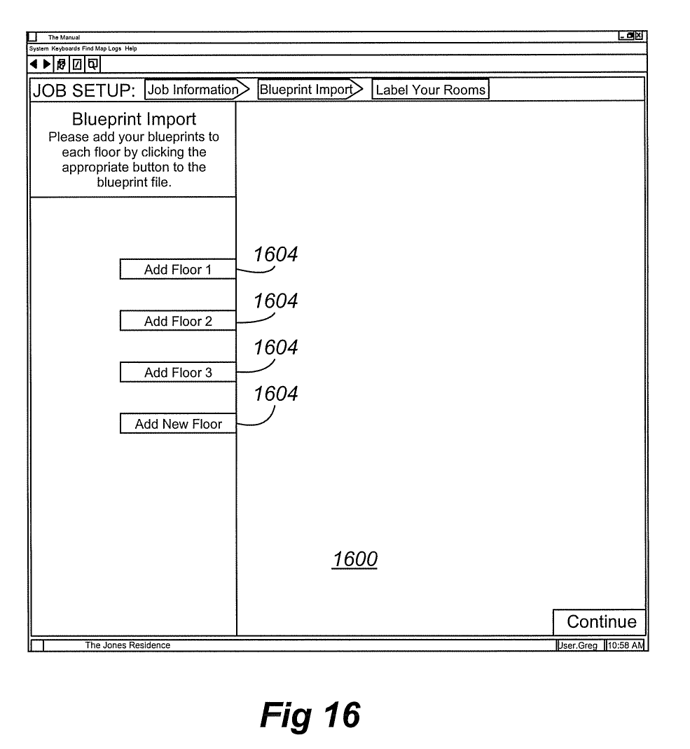

With reference again to FIG. 14, the job or project name or title 1502, and other job information is entered in the fields of the job information page 1500 (step 1408). In accordance with embodiments of the present invention, except for the project name field 1502, which requires the entry of at least some identifying information, the fields included in other groups 1504-1518 can be left blank. Following the entry of ajob name 1502 or other information in the job setup page 1500, blueprints or other depictions of the building plan can be imported into or associated with the building manual application 252 (step 1412). An example of the blueprint import page 1600 is illustrated in FIG. 16. As an example, the blueprint import page 1600 may be accessed by selecting a blueprint import button 1520 displayed as part of various screens included in or generated by the building manual application 252, or by selecting a continue button 1524 included in the job information page. For example, in accordance with embodiments of the present invention, blueprints or plans may be added for each floor of the building being depicted in the building manual 424 by selecting a button to add the desired floor.

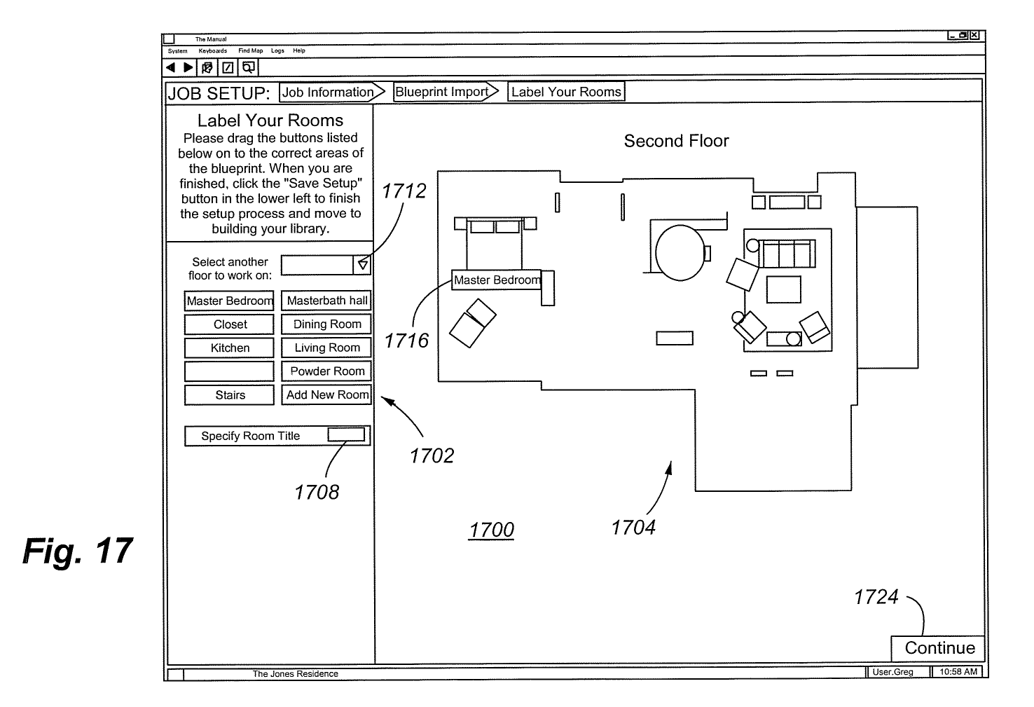

After blueprints or plans for one or more floors of the building being depicted have been imported, the rooms of the depicted floors can be labeled (step 1416). An example of a label your rooms page 1700 is illustrated in FIG. 17. The label your rooms page 1700 can be accessed by selecting a label your rooms button 1608 displayed in the blueprint import page 1600 or other pages. In accordance with embodiments of the present invention, rooms can be labeled by dragging titles 1702 that have been pre-provisioned from the margin of the screen to their appropriate location within the blueprint 1704 for the selected floor. In addition, a text entry field 1708 may be provided for specifying room titles that are not included in the pre-provisioned list. Accordingly, a user may enter a room title in the text entry field 1708, and then drag the title to the appropriate location within the blueprint or building plan 1704. A menu 1712 may also be provided to allow the user to select different floors for association with room titles. In FIG. 17, the label “master bedroom” 1716 has been dragged from the preprovisioned titles 1702 to the appropriate location within the building plan 1704.

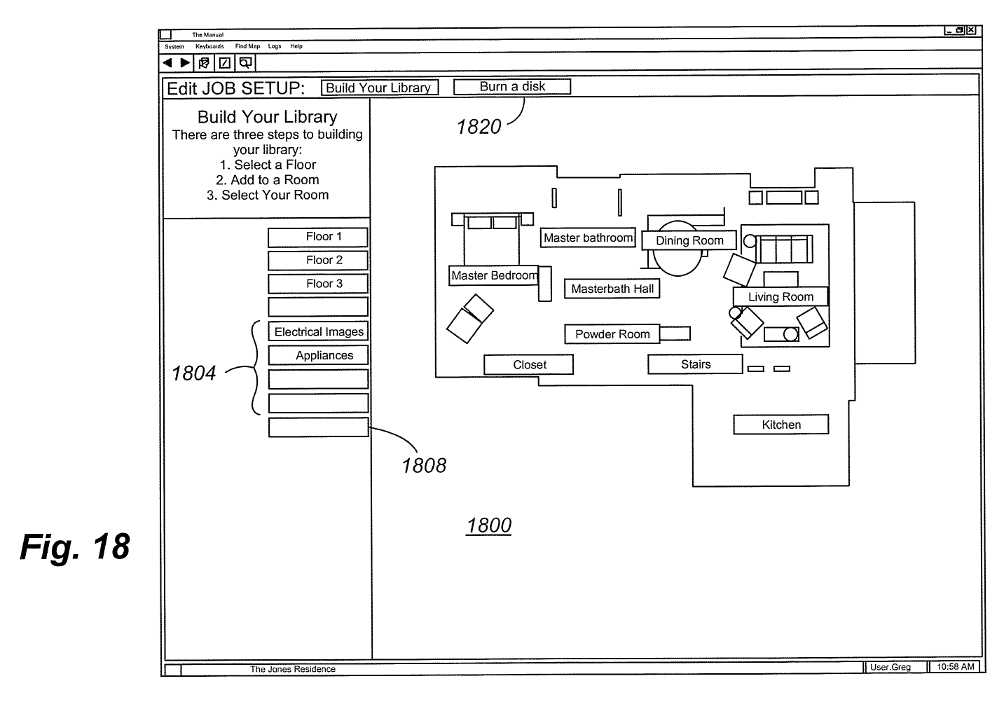

With reference again to FIG. 14, after labeling rooms, a determination may be made as to whether the job setup operations have been completed (step 1420). If job setup operations, such as adding additional blueprints, adding or editing room labels, or adding or editing job information, remains to be performed, the process may return to step 1408. Alternatively, if job setup is complete, the process may continue to step 1424, where user may select a build your library option. In accordance with embodiments of the present invention, a user may proceed to building a library of information that will be included with the completed building manual 424 even if job setup or other information is not yet complete. An example of a build your library page 1800 is illustrated in FIG. 18. The build your library page 1800 may be accessed by selecting a continue button 1724 displayed by the label your room page or pages 1700. At step 1428, the user may select a floor to add content to. In response to selecting a floor, the blueprint associated with the selected floor will be displayed. The building system information to be added may then be selected (step 1432). Different building systems may be selected using buttons 1804 displayed as part of the build your library page 1800. Examples of building systems that may be selected through a displayed button 1804 include the electrical system, appliances, plumbing and in-floor heat. In addition, an add new library button 1808 may be provided to allow the user to specify an additional building system. For example, the user may choose to add information regarding paint colors for the different rooms of the building. At step 1436, the room to which building system information is to be added is selected, and the desired information is added (step 1440).

Adding building system information can include specifying or importing information specific to the selected room and building system. For example, information related to the electrical system within a room can include digital images (still and/or moving) showing the location of wiring within the walls of the room, prior to the installation of drywall. In addition, different types of imported or provided information may be associated with a selected building system and room. For example, in addition to images showing the location of wiring or other electrical components, electrical system information for a room may include text identifying and describing installed electrical components. As another example, electronic versions of owner's manuals for equipment included in a particular building system may be added through the build your library screen 1800.

At step 1444, a determination may be made as to whether additional building system information is to be added to the building manual 424. If additional information is to be added, the process may return to step 1428. Alternatively, the process may proceed to step 1448, at which a determination may be made as to whether job and building system information is complete. If it is determined that the job and building system information is not complete or if changes are to be made, the process may return to step 1408. Alternatively, if it is determined that the job and building system information is complete, the building manual application 252 may be used to burn a disc. For example, the user may select a burn a disc button 1820 displayed as part of another page, such as a build your library page 1800 or a building system information content page 1900.

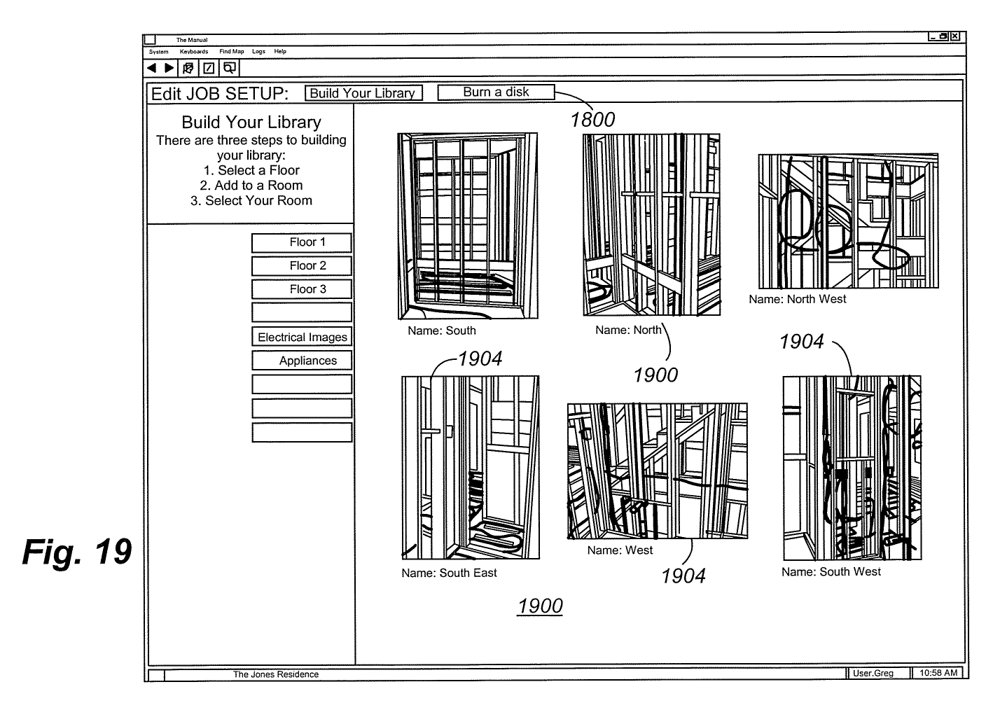

With reference to FIG. 19, an example of a building system information content page 1900 is illustrated. The example shown in the figure is of digital images 1904 depicting the location of electrical wiring and other components in a room prior to the installation of drywall, which will hide the location of the wiring.

Burning a disc 1452 can include writing data comprising building system information, blueprint and job information added to the building manual 424 to a portable data storage medium. In addition, programming instructions can be written to the disc that allow a user to modify and/or add to the information included as part of a building manual 424, for example to capture changes to building system information that are made after initial construction of the building.

After the building manual 424 has been burned to a disc or otherwise stored, the end user may open the program and access the job and building system information stored as part of the building manual 424 (step 1456). In general, the stored information may be accessed by selecting a desired floor, room and building system.

At step 1460, a determination may be made as to whether job and building system information or other information included in the building manual 424 is to be changed or added. If changes or additions are to be made, the end user may enter those changes and/or additions (step 1464). The entry of changes and/or additions may be made following the same or a similar process as that used to create the original version of the building manual 424. At step 1468, a determination may be made as to whether additional changes or additions are to be entered, or whether additional information is to be viewed. If additional changes or additions are to be entered, any process may return to step 1464. If additional changes or additions are not to be entered, the process may end, or the user may access other information associated with the building manual 424.

Although certain embodiments of the present invention have been discussed in connection with the creation of a CD-ROM or other removable storage device, it should be appreciated that other arrangements are possible. For example, the building manual 424 may be stored in a remote storage device and accessed by a user through a client computer in communication with a storage server. In addition, it should be appreciated that, as changes are made to a building manual 424, new versions of the building manual 424 may be created. Moreover, such new versions may be burned to a disc or otherwise finalized for access by an end user.

Although the various examples of pages presenting a plan of the subject building to a user have included a single floor of an example building, it should be appreciated that embodiments of the present invention are not so limited. For example, a building manual for a multiple story structure can include a building plan that comprises a floor plan for each story of the building. Furthermore, it should be appreciate that, although different pages allowing access to different types or combinations of information have been depicted, such examples are for illustration purposes, and are not intended to be limiting.

The foregoing discussion of the invention has been presented for purposes of illustration and description. Further, the description is not intended to limit the invention to the form disclosed herein. Consequently, variations and modifications commensurate with the above teachings, within the skill or knowledge of the relevant art, are within the scope of the present invention. The embodiments described hereinabove are further intended to explain the best mode presently known of practicing the invention and to enable others skilled in the art to utilize the invention in such or in other embodiments and with the various modifications required by their particular application or use of the invention. It is intended that the appended claims be construed to include alternative embodiments to the extent permitted by the prior art.

What is claimed is:

1. A method for organizing and displaying building system information, comprising:
opening a building manual application;
prompting a first user to enter identifying information;
receiving identifying information entered by the first user;
prompting the first user to enter building plan information;
in response to prompting the first user to enter building plan information, the first user importing building plan information for at least a first floor of the building;
prompting the first user to label areas of the building depicted by the plan information for the first floor of the building;
in response to prompting the first user to label areas of the building depicted by the plan information for the first floor of the building, the first user placing a label for at least a first area of the building depicted by the plan information for the first floor in the display of the plan information for the first floor of the building;
prompting the first user to add building system information for association with the first area of the first floor of the building;
in response to prompting the first user to add building system information for association with the first area of the first floor of the building, the first user:
selecting a first building system;
selecting the first area of the first floor of the building;
identifying first building system information;
associating the identified first building system information with the selected first building system and the selected first area of the first floor of the building;
storing the identifying information, the building plan information, and the first building system information as part of a first building manual.

2. The method of claim 1, further comprising:
opening the first building manual;
prompting an end user comprising at least one of the first user and a second user to select a building system;
in response to prompting the end user to select a building system, the end user selecting the first building system;
displaying to the end user the plan information for the first floor of the building;
receiving a selection of the first area of the building depicted by the plan information for the first floor from the end user;
in response to receiving a selection of the first area, displaying the first building system information to the end user.

3. The method of claim 2, wherein the first building system information includes at least a first image of the first building system in the first area of the building, and wherein displaying the first building system information includes displaying the at least a first image to the end user.

4. The method of claim 2, wherein the first building system information includes at least a first electronic copy of an appliance manual, and wherein displaying the first building system information includes displaying the at least a first electronic copy of the appliance manual to the end user.

5. The method of claim 1, further comprising:
in response to prompting a first user to enter building plan information, the first user importing building plan information for at least the first floor of the building and a second floor of the building;
receiving a selection by the first user of the first floor of the building, wherein prompting the first user to label areas of the building depicted by the plan information for the first floor of the building is performed in response to the selection of the first floor of the building by the first user;
receiving a selection by the first user of the second floor of the building;
in response to receiving a selection by the first user of the second floor of the building, prompting the first user to label areas of the building depicted by plan information for the second floor of the building;
in response to prompting the first user to label areas of the building depicted by the plan information for the second floor of the building, the first user placing a label for at least a first area of the building depicted by the plan information for the second floor of the building;
prompting the first user to add building system information for association with the first area of the second floor of the building;
in response to prompting the first user to add building system information for association with the first area of the second floor of the building, the first user:
selecting the first or a second building system;
selecting the first area of the first floor of the building;
identifying second building system information;
associating the identified second building system information with the selected first or second building system and the selected first area of the second floor of the building;
storing the identifying information, the building plan information, and the first building system information as part of a first building manual.

6. The method of claim 5, further comprising:
opening the first building manual;
prompting an end user comprising at least one of the first user and a second user to select a building system;
in response to prompting the end user to select a building system, the end user selecting the first building system;
prompting the end user to a select a floor of the building;
in response to prompting the end user to select a floor of the building, the end user selecting the first floor of the building;
displaying to the end user the plan information for the first floor of the building;
receiving a selection of the first area of the first floor of the building depicted by the plan information for the first floor from the end user;
in response to receiving a selection of the first area of the first floor, displaying the first building system information to the end user;
after displaying the first building system information to the end user, the end user selecting the second floor of the building;
in response to the selection of the second floor, displaying to the end user the plan information for the second floor of the building;
receiving a selection of the first area of the second floor of the building depicted by the plan information for the second floor from the end user;
in response to receiving a selection of the first area of the second floor, displaying the second building system information to the end user.

7. The method of claim 5, wherein the second building system information relates to the second building system, the method further comprising:
opening the first building manual;
prompting an end user comprising at least one of the first user and a second user to select a building system;
in response to prompting the end user to select a building system, the end user selecting the first building system;
prompting the end user to a select a floor of the building;
in response to prompting the end user to select a floor of the building, the end user selecting the first floor of the building;
displaying to the end user the plan information for the first floor of the building;
receiving a selection of the first area of the first floor of the building depicted by the plan information for the first floor from the end user;
in response to receiving a selection of the first area of the first floor, displaying the first building system information to the end user;
after displaying the first building system information to the end user, the end user selecting to access information related to the second building system and selecting the second floor of the building;
in response to the selection of the second building system information and the second floor, displaying to the end user the plan information for the second floor of the building;
receiving a selection of the first area of the second floor of the building depicted by the plan information for the second floor from the end user;
in response to receiving a selection of the first area of the second floor, displaying the second building system information to the end user, wherein the first building system information is of a different type than the second building system information.

8. The method of claim 2, further comprising:
opening the first building manual;
receiving a selection from the end user to update the first building system information;
receiving updated first building system information from the end user;
replacing the first building system information with the updated first building system information, wherein the updated first building system information is stored with the building manual.

9. The method of claim 2, wherein said selection of the first area is made by directing a cursor to the first label displayed within the plan.

10. The method of claim 1, wherein said storing includes burning a disc comprising the first building manual.

11. A system for organizing and presenting building system information, comprising:
digital data storage;
a user input;
a user output;
a processor;
a building plan, wherein the building plan is related to a first building, and wherein the building plan is stored in the digital data storage;
a plurality of data files stored in the digital data storage,
wherein at least a first of the plurality of data files is associated with a first area of the first building,
wherein at least a second of the plurality of images is associated with a second area of the first building,
a set of data stored in the digital data storage comprising a home page, wherein the home page includes a number of links, the links including a link to at least a first building plan page;
a set of data stored in the digital data storage comprising the at least a first building plan page,
wherein the at least a first building plan page includes a number of links, the links including a first link to first information associated with a first area of the building and the links including a second link to second information associated with a second area of the building,
wherein the first information associated with the first area is displayed through the user output to a user who enters a selection of the first link using the user input,
wherein the second information associated with the second area is displayed through the user output to a user who enters a selection of the second link using the user input.

12. The system of claim 11, wherein the first data file comprises a first image of at least a portion of a first building system associated with the first area of the first building,
wherein the second data file comprises a second image of at least a portion of the first building system associated with the second area of the first building.

13. The system of claim 12, wherein the first and second images comprise at least one of digital photographs and video clips.

14. The system of claim 11, wherein the links on the home page include a link to a second building plan page, the system further comprising:
a set of data stored in the digital data storage comprising the second building plan page,
wherein the second building plan page includes a number of links, the links including a third link to third information associated with the first area of the building and the links including a fourth link to fourth information associated with the second area of the building,
wherein the third information associated with the first area can be accessed through the user output by a user who enters a selection of the third link using the user input,
wherein the fourth information associated with the second area can be accessed through the user output by a user who enters a selection of the fourth link using the user input.

15. The system of claim 11, wherein the digital data storage comprises a removable storage medium.

16. The system of claim 11, wherein data is stored in the digital data storage in a number of folders, wherein the folders include at least first and second folders for first and second floors, and wherein the at least first and second folders each include at least first and second sub-folders for first and second building systems.

17. The system of claim 11, wherein data is stored in the digital data storage in a number of folders, wherein the folders include at least first and second folders for first and second building systems, and wherein the at least first and second folders each include at least first and second sub-folders for first and second floors.

18. The system of claim 11, further comprising:
a building manual application, wherein instructions comprising the application, said building plan and said data files are stored on a disc.

19. A digital building manual, comprising:
first information related to a first internal system of a building within at least a first area of the building;
second information related to the first internal system of the building within at least a second area of the building;
a plan of the building, wherein at least the first and second areas of the building are shown by the plan;
means for displaying the plan of the building, wherein a first link is displayed within the first area shown by the plan, wherein the first link provides access to at least the first information, wherein a second link is displayed within the second area shown by the plan, and wherein the second link provides access to at least the second information.

20. The method of claim 19, further comprising:
means for displaying the first information, wherein a selection of the first link causes the page for displaying the first information to be displayed; and
means for displaying the second information, wherein a selection of the second link causes the page for displaying the second information to be displayed.

21. The method of claim 18, further comprising:
means for storing the building manual, wherein an end user can access the building manual by reading information from the means for storing a building manual.
